(19) United States
(12) Patent Application Publication
(10) Pub. No.: US 2010/0207916 A1
(43) Pub. Date: Aug. 19, 2010

(54) PLASMA DISPLAY PANEL

(75) Inventors: Won-Hee Jeong, Suwon-si (KR); Jun-Yong Park, Suwon-si (KR); Joo-Sik Jung, Suwon-si (KR); Su-Bin Song, Suwon-si (KR); Eui-Jeong Hwang, (US); Seung-Hyun Son, (US)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/704,790

(22) Filed: Feb. 12, 2010

(30) Foreign Application Priority Data
Feb. 13, 2009 (KR) 10-2009-0012114
Aug. 28, 2009 (KR) 10-2009-0080699
Jan. 21, 2010 (KR) 10-2010-0005755

(51) Int. Cl. G09G 3/28; G06F 3/038

(52) U.S. Cl. 345/205; 345/63

(57) ABSTRACT

A plasma display panel (PDP) having high efficiency includes a front substrate and a rear substrate facing each other; element portions interposed between the front and rear substrates, and including a first element and a second element disposed in both sides of a main discharge space and a third and a fourth element respectively having a narrow width and protruding on the first element and the second element, wherein the first and second elements, and the third and fourth elements partition stepped spaces along a stepped surface in the main discharge space; sustain electrode pairs alternately disposed on the front substrate, extending along a first direction and causing mutual discharge; dielectric layers which are formed on the front substrate to cover the sustain electrode pairs and in which grooves are formed along a direction that is substantially perpendicular to the first direction; and address electrodes formed on the rear substrate and extending in a second direction that crosses the first direction.

### CROSS-REFERENCE TO RELATED APPLICATIONS

This application claims the benefit of Korean Patent Application No(s). 10-2009-0012114, filed on Feb. 13, 2009, 10-2009-0080699 filed on Aug. 28, 2009, and 10-2010-0005755 filed on Jan. 21, 2010 in the Korean Intellectual Property Office, the disclosures of which are incorporated herein in their entirety by reference.

### BACKGROUND

1. Field

One or more embodiments of the present invention relate to a plasma display panel (PDP).

2. Description of the Related Art

In general, a plasma display panel (PDP) is a type of flat display device that excites phosphor by using ultraviolet (UV) rays formed by plasma discharge and forms an image with visible light generated from the excited phosphor.

In general PDPs, barrier ribs that partition a plurality of discharge cells, are interposed between an upper substrate on which discharge electrodes are disposed and a lower substrate on which address electrodes are disposed, so that the upper and lower substrates are adhered to face each other, and an appropriate amount of discharge gas is injected into the discharge cells between the upper and lower substrates. Thereafter, a discharge voltage is applied to the discharge electrodes, exciting the phosphor coated on the discharge cells and forming an image with visible light generated from the excited phosphor.

FIG. 1 is a partial cross-sectional view of a general alternating current (AC) plasma display panel (PDP) 10. Referring to FIG. 1, the general AC PDP 10 includes an upper panel 50 on which an image is displayed to a user and a lower panel 60, which is combined with the upper panel 50 to be parallel thereto. Discharge sustain electrode pairs 12 in which a Y electrode 31 and an X electrode 32 form a pair, are disposed on a front substrate 11 of the upper panel 50, and address electrodes 22 are disposed on a rear substrate 21 of the lower panel 60 that faces the front substrate 11, to cross the Y electrode 31 and the X electrode 32. The Y electrode 31 and the X electrode 32 each include transparent electrodes 31a and 32a and bus electrodes 31b and 32b. A space formed by a pair of a Y electrode 31 and an X electrode 32 and the address electrodes 22 that cross the pair of the Y electrode 31 and the X electrode 32, is a unit cell and constitutes one discharge portion. A front dielectric layer 15 and a rear dielectric layer 25 are formed on the front substrate 11 and the rear substrate 21, respectively, to bury each X electrode 31, each Y electrode 32, and the address electrodes 22. A protective layer 16 is formed of magnesium oxide (MgO) on the front dielectric layer 15, and barrier ribs 30 are formed in front of the rear dielectric layer 25 so as to maintain a discharge distance and to prevent electrical and optical cross-talk between discharge cells. Phosphor layers 26 are coated on both sides of the barrier ribs 30 and on the entire surface of the rear dielectric layer 25 in which the barrier ribs 30 are not formed.

In the general AC PDP 10, a particular process has not been performed on the front dielectric layer 15. Thus, plasma formed in a transparent electrode to which voltage is applied, during sustain discharge is dispersed into the whole unit cells along an electrode side of the transparent electrode. In this case, when the plasma contacts the barrier ribs 30, loss of electrons and ions occurs, and the amount of current that is not conducive to discharge increases, and the efficiency of the unit cells is lowered.

### SUMMARY

One or more embodiments of the present invention include a plasma display panel (PDP) having high efficiency that is driven by low power and obtains high luminous brightness.

Additional aspects will be set forth in part in the description which follows and, in part, will be apparent from the description, or may be learned by practice of the presented embodiments.

According to one or more embodiments of the present invention, a plasma display panel (PDP) includes: a front substrate and a rear substrate facing each other; element portions interposed between the front and rear substrates, and including a first element and a second element disposed in both sides of a main discharge space and a third and a fourth element respectively having a narrow width and protruding on the first element and the second element, wherein the first and second elements, and the third and fourth elements partition stepped spaces along a stepped surface in the main discharge space; sustain electrode pairs alternately disposed on the front substrate, extending along a first direction and causing mutual discharge; dielectric layers which are formed on the front substrate so as to cover the sustain electrode pairs and in which grooves are formed along a direction that is substantially perpendicular to the first direction; and address electrodes formed on the rear substrate and extending in a second direction that crosses the first direction.

According to another aspect of the present invention, the grooves may be aligned in the unit cells defined by the element portions.

According to another aspect of the present invention, the grooves may be separated from the element portions by a predetermined distance.

According to another aspect of the present invention, the thickness of the dielectric layers in which the grooves are formed, may be less than the thickness of the dielectric layers in which the grooves are not formed.

According to another aspect of the present invention, the grooves may extend in parallel with a separation direction between the first element and the second element that are in the main discharge space.

According to another aspect of the present invention, the PDP may further include a protective layer covering the dielectric layers.

According to one or more embodiments of the present invention, a plasma display panel (PDP) includes: a front substrate and a rear substrate facing each other; element portions interposed between the front and rear substrates, and including a first element and a second element disposed in both sides of a main discharge space and a third and a fourth element respectively having a narrow width and protruding on the first element and the second element, wherein the first and second elements, and the third and fourth elements partition stepped spaces along a stepped surface in the main discharge space; sustain electrode pairs alternately disposed on the front substrate, extending along a first direction and causing mutual discharge; dielectric layers formed on the front substrate so as to cover the sustain electrode pairs and to have different thicknesses along a direction that is substantially perpendicular to the first direction; and address electrodes formed on the rear substrate and extending in a second direction that crosses the first direction.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a partial cross-sectional view of a general plasma display panel (PDP);

FIG. 2 is an exploded perspective view of a PDP according to an embodiment of the present invention;

FIG. 3 is a vertical cross-sectional view taken along line III-Ill of FIG. 2;

FIG. 4 is a vertical cross-sectional view taken along line IV-IV of FIG. 2;

FIG. 5 is a graph comparing the plasma efficiency of the PDP of FIG. 1 with the plasma efficiency of the general PDP; and

FIG. 6 is an exploded perspective view of a PDP according to another embodiment of the present invention.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

Moreover, it is to be understood that where is stated herein that one film or layer is “formed on” or “disposed on” a second layer or film, the first layer or film may be formed or disposed directly on the second layer or film or there may be intervening layers or films between the first layer or film and the second layer or film. Further, as used herein, the term “formed on” is used with the same meaning as “located on” or “disposed on” and is not meant to be limiting regarding any particular fabrication process.

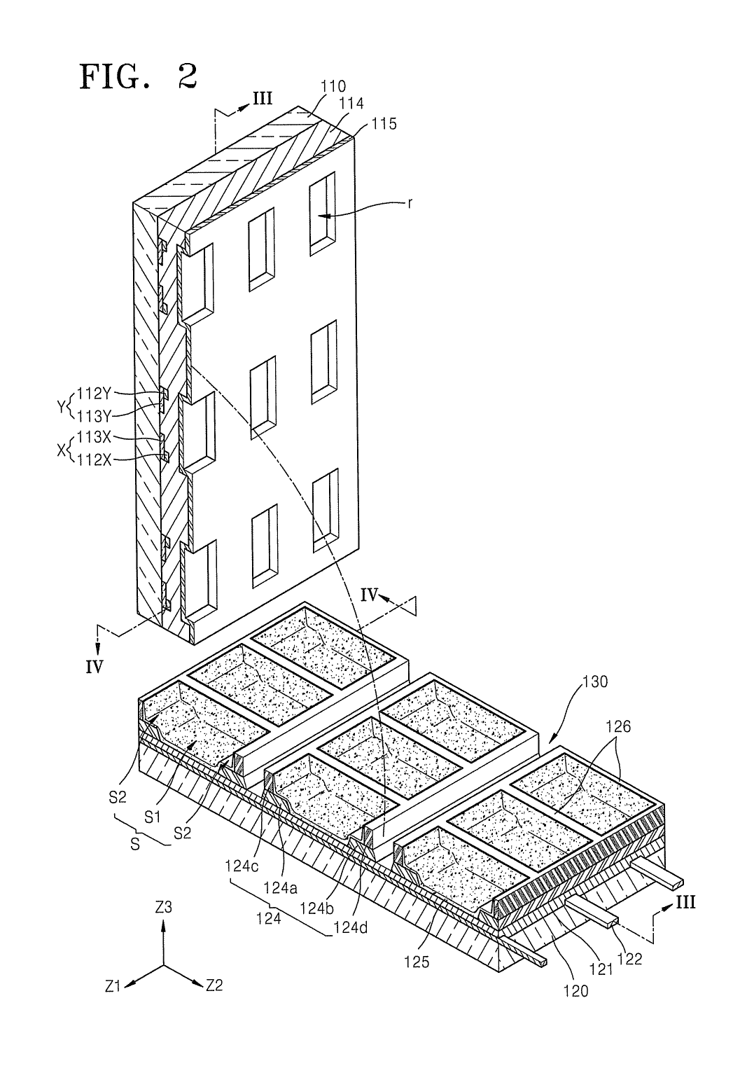

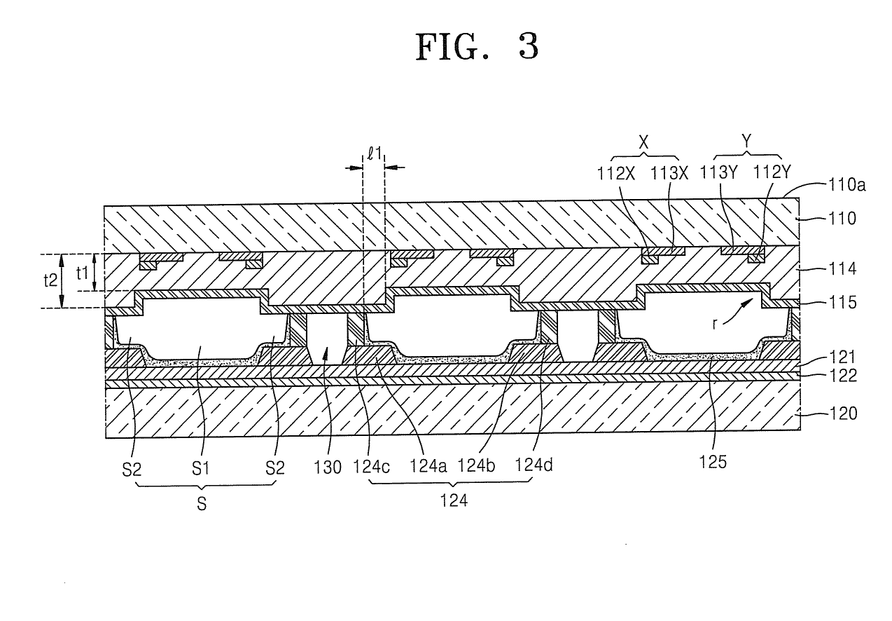

FIG. 2 is an exploded perspective view of a plasma display panel (PDP) according to an embodiment of the present invention, and FIG. 3 is a vertical cross-sectional view taken along line III-Ill of FIG. 2, and FIG. 4 is a vertical cross-sectional view taken along line IV-IV of FIG. 2.

The PDP includes a front substrate 110 and a rear substrate 120 that face each other with an interval therebetween, and element portions (including horizontal element portions 124 and vertical element portions 126 that define a plurality of unit cells S. For example, the barrier walls include the horizontal element portions 124 extending in one direction and the vertical element portions 126 extending to cross the extending direction of the horizontal element portions 124, and thus define unit cells S which are quasi-rectangular.

Each unit cell S denotes a minimal light-emitting unit that includes a discharge electrode pair (X,Y) formed to generate a mutual display discharge, and an address electrode 122 extending so as to intersect with the discharge electrode pair (X,Y). Each unit cell S is defined by the horizontal and vertical element portions 124 and 126 and thus forms a light-emission area independent from adjacent unit cells S. Each unit cell S includes a main discharge space S1 and stepped spaces S2 formed on either side of the main discharge space S1. The discharge electrode pair (X,Y) includes a sustain electrode X and a scan electrode Y that generate a display discharge. Each sustain electrode X includes a transparent electrode 113X formed of a phototransparent conductive material and a bus electrode 112X that electrically contacts the transparent electrode 113X and forms a power supply line. Each scan electrode Y includes a transparent electrode 113Y formed of a phototransparent conductive material and a bus electrode 112Y that electrically contacts the transparent electrode 113Y and forms a power supply line. The transparent electrodes 113X and 113Y have large widths and thus form a discharge electric field across a large area of each unit cell S. The bus electrodes 112X and 112Y have small widths so as not to obstruct visible light and form a power supply line that transmits a driving signal to the transparent electrodes 113X and 113Y.

The discharge electrode pairs (X,Y) may be buried in a dielectric layer 114 so as to be protected from direct collision with charged particles that participate in the display discharge. The dielectric layer 114 may be covered with a protective layer 115 formed of an MgO thin film. The protective layer 115 may induce secondary electron emission to thereby contribute to discharge activation.

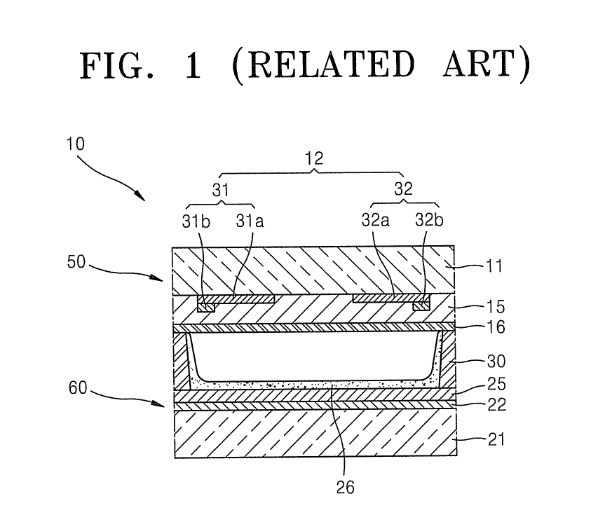

The scan electrodes Y and the sustain electrodes X may alternate with each other. Alternatively, as illustrated in FIG. 1, the scan electrodes Y and the sustain electrodes X may be arranged such that electrodes of the same kind are adjacent to each other in adjacent unit cells S. As illustrated in FIG. 1, a scan electrode Y, a sustain electrode X, a sustain electrode X, and a scan electrode Y are sequentially arranged, and thus a sustain electrode X in a unit cell S may be adjacent to a sustain electrode X in its adjacent unit cell S and similarly a scan electrode Y in a unit cell S may be adjacent to a scan electrode Y in its adjacent unit cell S. Due to this arrangement of the scan and sustain electrodes, an erroneous discharge in which a display discharge occurs across a cell boundary may be prevented, invalid power consumption may be reduced, and driving efficiency may be increased.

Referring to FIGS. 2 and 3, the address electrodes 122 are arranged on the rear substrate 120. The address electrodes 122 perform an address discharge together with the scan electrodes Y. The address discharge denotes an auxiliary discharge that helps the display discharge by occurring prior to the display discharge and thus by accumulating priming particles in each of the unit cells S. The address discharge occurs mainly within the stepped spaces S2 existing on the horizontal element portions 124 that are stepped. In other words, the scan electrodes Y and the address electrodes 122 cross each other in the stepped spaces S2 or in an area adjacent to the stepped spaces S2, and while a discharge voltage applied to the scan electrodes Y and the address electrodes 122 is concentrated in the stepped spaces S2 via portions of the dielectric layer 114 covering the scan electrodes Y and portions of the horizontal element portions 124 existing on the address electrodes 122, a high electric field sufficient for discharge firing is formed within the stepped spaces S2. The stepped spaces S2 are not artificially partitioned by other wall structures and instead extend from the main discharge space S1 so as to form a single unit cell S together with the main discharge space S1. Priming particles formed due to the address discharge in the stepped spaces S2 naturally spread to the main discharge space S1 and participate in the display discharge. The stepped spaces S2 are defined by the horizontal element portions 124, which are stepped, and have small sizes compared with the sizes of the main discharge space S1.

The address electrodes 122 may be buried in a dielectric layer 121 formed on the rear substrate 120, and the horizontal and vertical element portions 124 and 126 may be formed on a flat plane provided by the dielectric layer 121. The horizontal element portions 124 extends in one direction and the vertical element units 126 extends to cross the extending direction of the horizontal element portions 124, and the horizontal and vertical element portions 124 and 126 may form a matrix pattern that defines the unit cells S having quasi-rectangular shapes. For example, the horizontal element portions 124 may extend parallel to the scan electrodes Y, and the vertical element portions 126 may extend parallel to the address electrodes 122.

The horizontal element portions 124 each include the first element 124a and the second element 124b having a large width, and the third element 124c and the fourth element 124d formed on the first element 124a and the second element 124b, respectively to have a small width and to have a stepped shape. The stepped spaces S2 defined by the horizontal element units 124 exist between the scan electrodes Y and the address electrodes 122, and the scan electrodes Y and the address electrodes 122 generate an address discharge in the stepped spaces S2. Portions of the dielectric layer 114 (or the protective layer 115) that cover the scan electrodes Y, and portions of the first elements 124a that exist on the address electrodes 122 may form discharge surfaces and generate an address discharge. In other words, since the portions of the dielectric layer 114 covering the scan electrodes Y and the portions of the first elements 124a existing on the address electrodes 122 have a high dielectric constant, a discharge electric field may be concentrated in the stepped spaces S2 and an intensive address discharge may occur in the stepped spaces S2.

In a related art barrier wall structure, a discharge occurs between the scan electrodes Y and the address electrodes 122 along a long discharge path corresponding to the height of a cell. However, in the barrier wall structure according to an embodiment of the present invention having the first elements 124a and the second element 124b formed to have a predetermined height toward the scan electrodes Y, a discharge path between the scan electrodes Y and the address electrodes 122 has a decreased gap on the first elements 124a and the second element 124b. Thus, compared with the related art barrier wall structure, the barrier wall structure according to an aspect of the present invention may produce as many priming particles as the number of priming particles produced in the related art barrier wall structure, at an address voltage lower than that used in the related art barrier wall structure, and thus driving power consumption may be reduced. When an address voltage equal to that used in the related art barrier wall structure is applied, more priming particles than those produced in the related art barrier wall structure may be produced, and thus luminous efficiency may increase. The element portions 124 and 126 may be formed of a material having a dielectric constant equal to or greater than a certain level so as to form a high address electric field within the stepped space S2 via the first elements 124a and the second elements 124b, which are parts of the element portions 124 and 126. For example, the element portions 124 and 126 may be formed of a dielectric material such as PbO, B₂O₃, SiO₂, or TiO₂.

A channel space 130 may be defined between adjacent horizontal element portions 124 that define different unit cells S, and extend in a lengthwise direction of the horizontal element portions 124. The channel spaces 130 are non-discharge areas where a discharge is not supposed to occur. The channel spaces 130 serve as impurity gas flow paths in an exhaust process where impurity gas existing between the front substrate 110 and the rear substrate 120 attached to and facing each other is exhausted, thereby reducing flow resistance and the tact time of the exhaust process.

Meanwhile, the stepped spaces S2 are formed on either side of the main discharge space S1. More specifically, the stepped spaces S2 are formed on the sides of a scan electrode Y and a sustain electrode X, respectively. An intensive address discharge occurs using one of the stepped spaces S2 which is on the side of the scan electrode Y, while the stepped space S2 formed on the side of the sustain electrode X establishes an equilibrium of each unit cell S together with the stepped space S2 on the side of the scan electrode Y. By designing the unit cells S each having a well-balanced shape, a display discharge may have a balanced discharge strength not biased toward any of the scan electrodes Y and the sustain electrodes X and have a nearly symmetrical shape. Therefore, a brightness distribution within each unit cell S may have a symmetrical shape, a light-emitting center representing maximum brightness may be approximately identical with the geometrical center of each unit cell S, and degradation of the quality of display due to an asymmetrical brightness distribution may be prevented.

A phosphor layer 125 is formed in each unit cell S. The phosphor layers 125 interact with ultraviolet (UV) rays produced as a result of the display discharge, thereby generating visible rays of different colors. For example, red (R), green (G), and blue (B) phosphor layers 125 are formed in the unit cells S according to colors to be displayed, so that the unit cells S are classified into R, G, and B subpixels. Each of the phosphor layers 125 is formed on a surface among adjacent first elements 124a and second elements 124b, on upper surfaces of the first elements 124a and the second elements 124b, and on side surfaces of the third elements 124c and the fourth elements 124d. In other words, each of the phosphor layers 125 is continuously formed across a corresponding main discharge space S1 and corresponding stepped spaces S2. This phosphor structure may be obtained using a continuous coating process where phosphor paste is coated on a single row of unit cells S at a time. In particular, portions of the phosphor layers 125 formed on the first elements 124a and the second elements 124b are close to the discharge electrode pairs (X,Y), which generate a display discharge, and thus may be effectively excited. Also, the portions of the phosphor layers 125 formed on the first elements 124a and the second elements 124b are closer to the front substrate 110, which forms a display plane, than the other portions of the phosphor layers 125 and face a display direction, so that visible light VL generated in the phosphor layers 125 may be immediately emitted to the outside via the front substrate 110 above the phosphor layers 125, thereby increasing the efficiency of extracting visible light.

In a related art phosphor structure where a large portion of a phosphor layer is attached to side surfaces of a barrier wall, flowable phosphor paste fails to adhere to the barrier walls due to gravity and flows down, and thus phosphor remaining on the side surfaces has a small thickness or an irregular thickness. In addition, visible light is discharged in the side surface direction of the barrier walls, and thus light extraction efficiency is lowered. In this embodiment of the present invention, the phosphor layer 125 existing on the upper surfaces of the first elements 124a and the second elements 124b, which are close to the display plane and face the display direction, are formed due to the structure of the stepped element portions 124, and thus phosphor paste remains on and is stably attached to the upper surfaces of the first elements 124a and the second element 124b. Therefore, the efficiency of extracting the visible light VL emitted upward from the phosphor layers 125 may increase, and light-emission brightness may increase.

Meanwhile, the front dielectric layer 114 includes grooves r formed in a direction perpendicular to the first direction Z1 in which the sustain electrode pair (X, Y) extends. One of the grooves r is discontinuously formed in a lower portion of the front dielectric layer 114. The groove r may be a quadrangular shape. In this case, the lengthwise direction of the groove r is substantially perpendicular to the first direction. In other words, the groove r extends in the direction perpendicular to the first direction, and the grooves r are separated from each other by a predetermined distance.

The grooves r are formed by removing part of the front dielectric layer 114 from the lower portion of the front dielectric layer 114. Thus, the thickness of the front dielectric layer 114 in which the grooves r are formed, is less than the thickness of the front dielectric layer 114 in which the grooves r are not formed. In other words, the thickness of the front dielectric layer 114 is not uniform and may be different. Particularly, the thickness of the front dielectric layer 114 may be different in the direction perpendicular to the first direction.

FIG. 3 is a vertical cross-section taken along line III-Ill of FIG. 1. Referring to FIG. 3, first and second element areas S2 formed on either side of each main discharge space S1 are light-emission areas in which display light-emission is concentrated by extracting visible light from the phosphor layers 125, which are close to a display plane 110a, with high efficiency. Since the bus electrodes 112X and 112Y, which constitute a part of the discharge electrode pairs (X,Y), may be formed of an opaque metal conductive material, the bus electrodes 112X and 112Y are disposed away from the first and second element areas S2 where light emission is concentrated.

Meanwhile, as illustrated in FIGS. 3 and 4, the grooves r are aligned in the unit cell S formed by the barrier rib portions 124. Thus, the grooves r are not formed in the adjacent unit cell S beyond the barrier rib portions 124. The groove r extends in parallel with a separation direction Z2 between the first element 124a and the second element 124b which are in the main discharge space S1. Thus, the thickness of the front dielectric layer 114 is not uniform and may be different. In particular, the thickness of the front dielectric layer 114 in a portion where the groove r is formed in a direction perpendicular to the first direction indicates t1, and the thickness of the front dielectric layer 114 in a portion without the groove r indicates t2, so that the thickness of the front dielectric layer 114 may be not uniform and may be different.

The grooves r are separated from the element portions 124 and 126 by a predetermined distance and are formed in the lower portion of the front dielectric layer 114. That is, as illustrated in FIG. 3, the grooves r are separated from the horizontal element portions 124 by a distance I1, and as illustrated in FIG. 4, the grooves r are separated from the vertical element portion 126 by a distance I2.

Meanwhile, the lower portion of the front dielectric layer 114 may be covered with a protective layer 115 formed as a magnesium oxide (MgO) thin film, and the protective layer 115 may be conducive to induction of emission of secondary electrons and to activation of discharge. Since the grooves r are formed in the lower portion of the front dielectric layer 114 and the protective layer 115 is formed to cover the lower portion of the front dielectric layer 114, the protective layer 115 is also formed at insides of the grooves r.

The address electrodes 122 are disposed on the rear substrate 120 to extend across the unit cells S in a direction that cross the sustain electrode pairs (X, Y). The address electrodes 122 perform address discharge together with the scan electrodes Y. The address electrodes 122 and the scan electrodes Y cross one another in the unit cell S.

A discharge voltage applied between the scan electrodes Y and the address electrodes 122 is concentrated around the grooves r via the front dielectric layer 114 covering the scan electrodes Y and the horizontal element portions 124 disposed on the address electrodes 122. There is a large possibility that firing discharge may occur via the grooves r that provide the shortest discharge path.

A discharge gas (not shown) that acts as an UV light generator is injected into the unit cells S. The discharge gas may be a multi-element gas in which xenon (Xe), krypton (Kr), helium (He), neon (Ne), and the like capable of providing UV light through discharge excitation are mixed at a determined volumetric ratio. A related art high-Xe display panel provides high luminous efficiency, but requires a high discharge firing voltage. Thus, such a related art high-Xe display panel has limitations in practical applications or extended applications when considering various circumstances such as an increase in driving power consumption and a circuit redesign for increasing rated power. However, in this embodiment of the present invention where a high electric field favorable to address discharge is formed through the first elements 124a and the second elements 124b of the horizontal element portions 124, a sufficient number of priming particles for discharge firing may be obtained, and thus a high-Xe plasma display may be implemented without an excessive increase in a discharging firing voltage, thereby significantly increasing luminous efficiency.

As described above, in an embodiment of the present invention, when the unit cells S are formed, the grooves r are discontinuously formed in the front dielectric layer 114, which is formed in the front substrate 110, in a direction that is substantially perpendicular to the first direction (the direction in which the sustain electrode pair (X, Y) extends) so that loss of plasma during sustain discharge may be reduced and the efficiency of the PDP may be improved. Furthermore, the volume of plasma discharge may be suppressed, and the amount of current may be reduced, and power consumption may be reduced.

Due to the grooves r formed in the lower portion of the front dielectric layer 114, the thickness of the front dielectric layer varies according to the location of the front dielectric layer 114, and thus, an electrostatic capacity of the PDP varies. As the electrostatic capacity of the PDP increases, the amount of charges accumulated increases. Thus, a plasma discharge distance is maintained so that loss of plasma may be reduced and the efficiency of the PDP may be improved.

The following experiment for confirming the efficiency of the PDP shown in FIGS. 2 through 4 according to an embodiment of the present invention in comparison with the general PDP shown in FIG. 1 was performed.

In the case where a general PDP in which a groove is not formed in a dielectric layer 15 formed on a front substrate 11, the thickness of the dielectric layer 15 formed on the front substrate 11 is uniform between the sustain electrode pairs 12. According to the experiment, the thickness of the dielectric layer 15 between the discharge electrode pairs of the general PDP in which the groove is not formed in the dielectric layer 15 formed on the front substrate 11 was 30 micrometers. Meanwhile, as illustrated in FIG. 3, the thickness t1 of the front dielectric layer 114 formed in the front substrate 110 in the PDP according to the present embodiment of the present invention in which the grooves r were formed, was 15 micrometers, and the thickness t2 of the front dielectric layer 114 in which the grooves r were not formed, was 30 micrometers.

Efficiency that satisfies the following equation that is a conversion ratio of UV rays to the entire energy, was measured by using the above structures: Efficiency=(UV energy)/(supplied power).

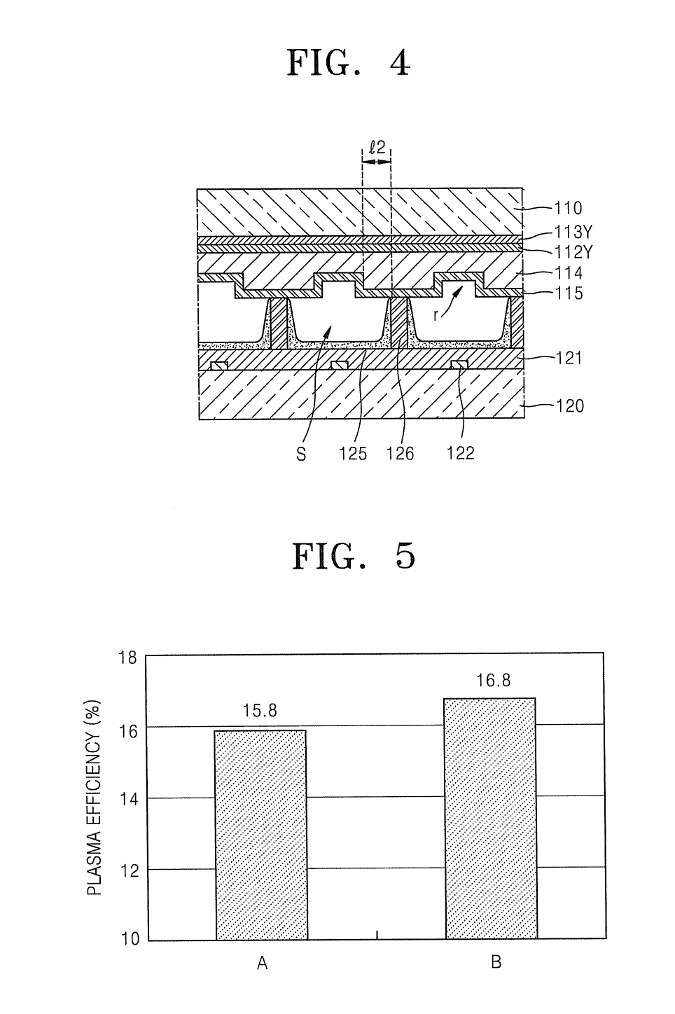

FIG. 5 is a graph comparing the plasma efficiency of a PDP according to an embodiment of the present invention with the plasma efficiency of a general PDP. Referring to FIG. 5, a general PDP (A) including a dielectric layer with a uniform thickness shows the plasma efficiency of 15.8%, whereas a PDP (B) according to an embodiment of the present invention including a dielectric layer with a non-uniform thickness and with grooves formed in the dielectric layer, shows the plasma efficiency of 16.8%, which is higher than 15.8% of the plasma efficiency of the general PDP (A).

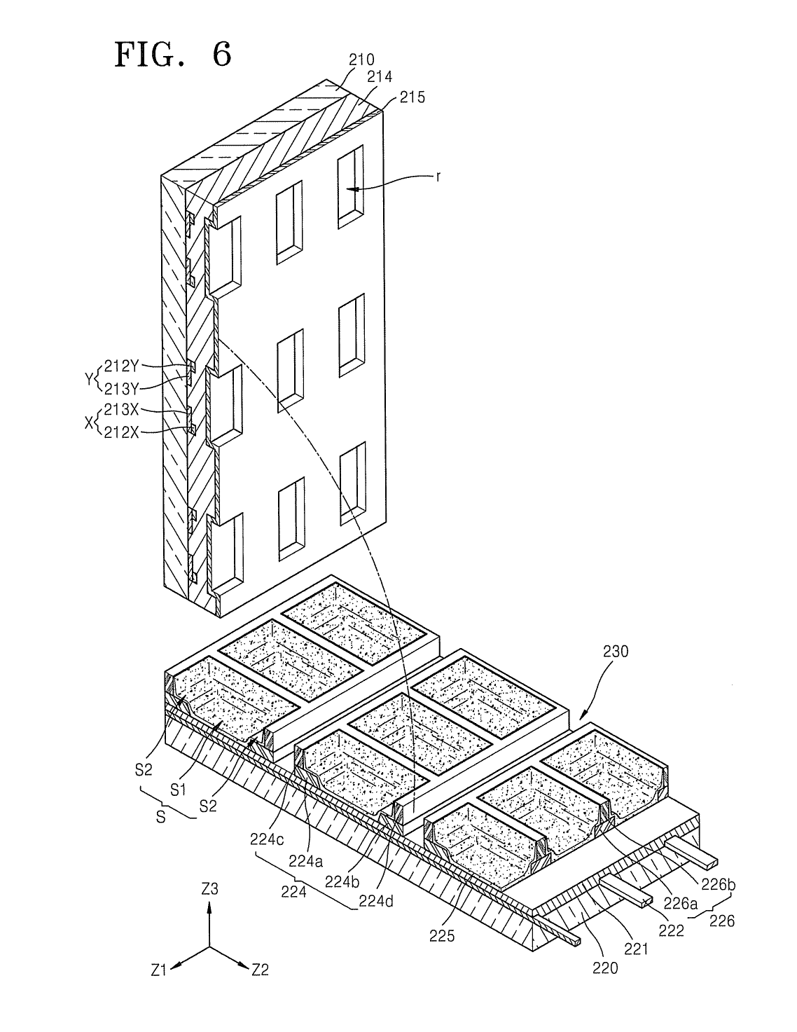

FIG. 6 is an exploded perspective view of a PDP according to another embodiment of the present invention. The PDP includes a front substrate 210 and a rear substrate 220 arranged to be separated by a predetermined distance from each other and to face each other. First through fourth elements 224a, 224b, 224c, and 224d extending in a direction Z1 are arranged at the rear substrate 220. Discharge electrodes X and Y are arranged at the front substrate 210.

Each of the first and second elements 224a and 224b is formed to have a wide width. The first and second elements 224a and 224b make a pair by facing each other in an inward direction of a discharge cell S.

A stepped surface is formed along the first elements 224a and the third elements 224c by forming the third elements 224c having a relatively narrow width on the first element 224a having a relatively wide width. Similarly, a stepped surface is formed along the second elements 224b and the fourth elements 224d by forming the fourth elements 224d having the relatively narrow width on the second element 224b having the relatively wide width.

A channel space 230 is defined between the third and fourth elements 224c and 224d which define different discharge cells S. The channel space 230 provides a passage for flow of impurity gas so that a flow resistance in a process of exhausting impurity gas remaining in a panel may be reduced. Also, address electrodes 222 are arranged on the rear substrate 220, and the address electrodes 222 are covered by a dielectric layer 221.

A fluorescent layer 225 is formed on the dielectric layer 221 between the first and second elements 224a and 224b. The fluorescent layer 225 generates visible rays of different colors, for example, red (R), green (G), and blue (B), by interacting with an ultraviolet ray generated as a result of the display discharge.

The position of the fluorescent layer 225 is not limited to the position between the first and second elements 224a and 224b in the cell S, and may extend to a neighboring position so as to cover parts of the first and second elements 224a and 224b. As illustrated in the drawing, the fluorescent layer 225 may continuously extend to the upper surfaces of the first and second elements 224a and 224b, and further to the side surfaces of the third and fourth elements 224c and 224d.

The PDP of FIG. 6 may include fifth and sixth elements 226a and 226b which extend across the third and fourth elements 224c and 224d in a direction Z2 crossing the third and fourth elements 224c and 224d. Referring to FIG. 6, the fifth element 226a having a relatively wide width and the sixth element 226b having a relatively narrow width and formed on the fifth element 226a are arranged at the rear substrate 220.

A distance between the first and second elements 224a and 224b is longer than a distance between each of the fifth elements 226a so that a unit cell S including a main discharge space S1 and stepped spaces S2 is a quadrangular shape relatively extending in a direction Z2. Here, a groove r extends in parallel with the separation direction Z2 between the first element 224a and the second element 224b which are in the main discharge space S1, and extends to be perpendicular to a direction Z1 of discharge electrodes (X,Y).

As described above, according to the one or more of the above embodiments of the present invention, the efficiency of a PDP may be improved. In addition, power consumption may be remarkably reduced so that the PDP may be driven by low power.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A plasma display panel (PDP) comprising:
a front substrate and a rear substrate facing each other;
element portions interposed between the front and rear substrates, and comprising a first element and a second element disposed in both sides of a main discharge space and a third and a fourth element respectively having a narrow width and protruding on the first element and the second element, wherein the first and second elements, and the third and fourth elements partition stepped spaces along a stepped surface in the main discharge space;
sustain electrode pairs alternately disposed on the front substrate, extending along a first direction and causing mutual discharge;
dielectric layers which are formed on the front substrate so as to cover the sustain electrode pairs and in which grooves are formed along a direction that is substantially perpendicular to the first direction; and
address electrodes formed on the rear substrate and extending in a second direction that crosses the first direction.

2. The PDP of claim 1, wherein the grooves are aligned to correspond to the main discharge space defined by the element portions.

3. The PDP of claim 2, wherein the grooves are separated from the element portions by a predetermined distance.

4. The PDP of claim 2, wherein a thickness of the dielectric layers in which the grooves are formed, is less than the thickness of the dielectric layers in which the grooves are not formed.

5. The PDP of claim 1, wherein the grooves extend in a parallel direction to the main discharge space.

6. The PDP of claim 1, further comprising a protective layer covering the dielectric layers.

7. A plasma display panel (PDP) comprising:
a front substrate and a rear substrate facing each other;
element portions interposed between the front and rear substrates, and comprising a first element and a second element disposed in both sides of a main discharge space and a third and a fourth element respectively having a narrow width and protruding on the first element and the second element, wherein the first and second elements, and the third and fourth elements partition stepped spaces along a stepped surface in the main discharge space;
sustain electrode pairs alternately disposed on the front substrate, extending along a first direction and causing mutual discharge;
dielectric layers formed on the front substrate so as to cover the sustain electrode pairs and to have different thicknesses along a direction that is substantially perpendicular to the first direction; and
address electrodes formed on the rear substrate and extending in a second direction that crosses the first direction.

8. A plasma display panel (PDP) comprising:
a front substrate and a rear substrate facing the front substrate;
element portions interposed between the front and rear substrates forming a plurality of unit cells, the element portions comprising a first element and a second element disposed on both sides of each one of the plurality of unit cells and a third and a fourth element respectively disposed on the first and second elements, the third and fourth elements having a width narrower then a width of the first and second elements, wherein the first and second elements, and the third and fourth elements form a stepped space in each one of the plurality of unit cells;
sustain electrode pairs disposed on the front substrate and located over each of the plurality of unit cells;
dielectric layers formed on the front substrate so as to cover the sustain electrode pairs; and
address electrodes formed on the rear substrate and extending in a direction that crosses the sustain electrode pairs,
wherein a plurality of grooves are formed on the dielectric layers, and each groove is located over a corresponding one of each of the plurality of unit cells.

9. The PDP of claim 8, wherein each one of the plurality of grooves is separated from the element portions by a predetermined distance.

10. The PDP of claim 8, wherein a thickness of the dielectric layers on which the plurality of grooves are formed, is less than the thickness of the dielectric layers on which the grooves are not formed.

11. The PDP of claim 8, wherein the plurality of grooves extend in a parallel direction with a separation between the first element and the second element that are in the unit cells.

12. The PDP of claim 8, further comprising a protective layer covering the dielectric layers.
